(19) United States
(12) Patent Application Publication
(10) Pub. No.: US 2007/0228688 A1
(43) Pub. Date: Oct. 4, 2007

(54) Energy efficient bicycle

(76) Inventor: Cyrus O. Varan, Whangaparaoa (NZ)

Correspondence Address: JAECKLE FLEISCHMANN & MUGEL, LLP, 190 Linden Oaks, ROCHESTER, NY, 14625-2812, US

(21) Appl. No.: 11/376,892

(22) Filed: Mar. 16, 2006

(51) Int. Cl. B62M 1/02

(52) U.S. Cl. 280/261

(57) ABSTRACT

The energy efficient bicycle provided includes a seat mounted to a frame, and front and rear wheels rotatably mounted to a frame. The rear wheel is positioned approximately below or rearward of the seat. The bicycle includes a pedal crank assembly rotatably mounted to the frame. The pedal crank assembly is positioned coaxial with the rear wheel. The pedal crank assembly is driveably coupled with the rear wheel to allow for propulsion of the bicycle. The bicycle may further include a gear changing mechanism including a driving gear set engaged with the pedal crank assembly, and a driven gear set fixedly coupled to the rear wheel. The driving gear set is engaged with the driven gear set using a drive belt. The gear changing mechanism operates to move the drive belt along the driving and driven gear sets to change gears on the bicycle.

### TECHNICAL FIELD

The present invention relates to an energy efficient bicycle; and particularly to an energy efficient bicycle including a pedal crank assembly positioned rearward of a bicycle seat and coaxial with a rear driven wheel.

### BACKGROUND OF THE INVENTION

A conventional bicycle typically includes a pedal crank assembly that is used to propel the bicycle in a desired direction. In some of the first bicycles that were manufactured, the pedal crank assembly was fixedly coupled to the front wheel.

More recent bicycle arrangements are configured so that the pedal crank assembly is rotatably mounted to a bicycle frame and positioned forward of the seat and rearward of the front wheel, wherein the pedal crank assembly is coupled to a rear driven wheel by a chain. Positioning the pedal crank assembly forward of the seat and rearward of the front wheel presents a number of drawbacks and deficiencies. For instance, when the pedal is positioned at five o'clock, a significant amount of force is used to place the crank bar in tension, which is an inefficient use of energy when the goal is to use the pedaling force to rotate the drive gear.

In addition, positioning the pedal crank assembly forward of the seat and rearward of the front wheel creates undesirable dead spots in the pedal stroke. Since it is easier for the human leg to apply a vertically directed force compared to a horizontally directed force when on a bicycle, dead spots are generally present at the twelve o'clock and six o'clock pedaling positions. As a result, the pedaling stroke is generally least efficient during the up-stroke and down-stroke positions thereby resulting in a reduction in speed capability due to interruption and discontinuity in the pedal stroke.

Further, it is common for the chain to extend generally horizontally from the pedal crank assembly to the rear driven wheel. The horizontal position of the chain may present additional problems. For example, if a horizontally positioned chain is used on a mountain bicycle, rugged terrain may contact the chain in such a way to derail it from the pedal crank assembly or the driven wheel. This results in an inconvenience for the bicycle rider. A typical bicycle arrangement also uses front and rear derailleurs to change between various gears located on the pedal crank assembly and the rear driven wheel. However, derailleurs are often in need of adjustment or repair to provide a smooth transition between gears. As such, the use of multiple derailleurs may increase the maintenance on the bicycle, decrease the bicycle's reliability, and increase the cost of manufacturing the bicycle. Further, derailing is feasible only when the cyclist is riding and the bike is in motion, which is not always convenient.

Accordingly, there exists a need for an energy efficient bicycle that reduces the amount of tension force wasted for being applied and placed on the crank bar during the pedaling stroke. There also exists a need to reduce undesirable dead spots in the pedal stroke. Furthermore, there exists a need reduce the probability that the chain will derail from the pedal crank assembly and the rear driven wheel. In addition, there exists a need to reduce the required maintenance on the bicycle, increase the reliability of the bicycle, and reduce the cost of manufacturing the bicycle. The present invention fills these needs as well as other needs.

### SUMMARY OF THE INVENTION

In order to overcome the above stated problems, the present invention provides an energy efficient bicycle including a pedal crank assembly positioned approximately below or rearward of a bicycle seat and coaxial with a rear driven wheel. The position of the pedal crank assembly in accordance with the present invention allows the upper portion of a bicycle rider's body to bend forward when cycling thereby enabling the rider to produce more driving force on pedal crank assembly compared to a rider having his or her legs cramped under the bent body where pedal crank assembly is positioned forward of the seat. The present invention includes additional advantages, which will be described below.

Specifically, the energy efficient bicycle includes a seat mounted to a frame, and front and rear wheels rotatably mounted to the frame. The rear wheel is positioned approximately below or rearward of the seat and the front wheel is positioned forward of the seat. In one aspect, the pedal crank assembly is rotatably mounted to the frame, positioned no further forward than approximately underneath the seat and coaxial with the rear wheel. The pedal crank assembly is driveably coupled with the rear wheel to allow for propulsion of the bicycle.

The bicycle may further include an auxiliary gear arrangement including an auxiliary axle rotatably coupled to the frame, first and second auxiliary gears fixedly coupled to the auxiliary axle, and a cutch gear fixedly coupled to the rear wheel. The pedal crank assembly is engaged with the first auxiliary gear using a drive chain, and the second auxiliary gear is engaged with the clutch gear using a drive belt, which driveably couples the pedal crank assembly to the rear wheel. The first auxiliary gear may be positioned above the pedal crank assembly to reduce the chance that the drive chain will become disengaged from the first auxiliary gear and pedal crank assembly due to objects striking drive chain on rough terrain.

Moreover, the present invention includes a gear changing mechanism that may be used to change the gears on the bicycle. The gear changing mechanism includes frustum-shaped driving and driven gear sets. The driving gear set is fixedly coupled to the auxiliary axle in place of the second auxiliary gear mentioned above, and the driven gear set fixedly coupled to the rear wheel in place of the clutch gear mentioned above. The driving belt is used to engage the driving gear set with the driven gear set. Further, a cable is coupled to the auxiliary axle and is used to tilt the auxiliary axle to release and engage the driving belt from at least one of the driving gear set and the driven gear set. A guide member is positioned on opposite sides of the drive belt and is slidably mounted within at least one track to change the position of the drive belt when the cable is in the release position. The gear change mechanism may also be used in a conventional bicycle arrangement wherein the pedal crank assembly is positioned forward of the seat and rearward of the front wheel.

### BRIEF DESCRIPTION OF THE DRAWINGS

The above-mentioned and other features and advantages of this invention, and the manner of attaining them, will become appreciated and be more readily understood by reference to the following detailed description of one embodiment of the invention in conjunction with the accompanying drawings, wherein:

FIG. 1 is a side view of a conventional bicycle arrangement including a pedal crank assembly positioned forward of a bicycle seat and rearward of a front wheel;

FIG. 2 is a side view of a bicycle including a pedal crank assembly positioned rearward of a bicycle seat and coaxial with an axis of a rear driven wheel in accordance with the present invention;

FIG. 3 is a cross-sectional view of a rear portion of the bicycle shown in FIG. 2 taken along line 3-3;

FIG. 4 is a partial enlarged side view of the pedal crank assembly and a portion of an auxiliary gear arrangement;

FIG. 5 is a side view of a bicycle including the present invention showing the force imposed on the pedal crank assembly during the down-stroke portion of the pedaling motion;

FIG. 6 is an alternative embodiment of the rear portion of the bicycle shown in FIG. 2 incorporating a gear change mechanism in accordance with the present invention;

FIG. 7 is a cross-sectional view taken along line 7-7 in FIG. 6 with portions of the bicycle removed to show the gear change mechanism;

FIG. 8 is a side view of a conventional bicycle arrangement including the gear change mechanism shown in FIGS. 6 and 7;

FIG. 9 is a cross-sectional view taken along line 9-9 in FIG. 8 showing the gear exchange mechanism;

FIG. 10 is a side view of a convention bicycle arrangement including an alternate scheme of gear change mechanism shown in FIG. 8;

FIG. 11 is a partial enlarged side view of the pedal crank assembly and a portion of the auxiliary gear arrangement when the gears are directly engaged in favor of elimination of a chain connection, and a side view of another portion of the auxiliary gear arrangement and a clutch gear when the gears are directly engaged in favor of a belt connection; and

FIG. 12 is an alternative embodiment of the partial enlarged side view shown in FIG. 11 showing the pedal crank assembly and a portion of the auxiliary gear arrangement in direct engagement, and another portion of the auxiliary gear arrangement in engagement with the clutch gear using a drive belt.

### DESCRIPTION OF THE PREFERRED EMBODIMENT

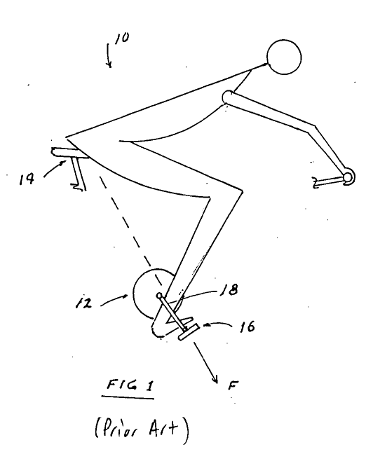

Referring to the drawings in detail, and specifically to FIG. 1, a conventional bicycle arrangement is shown and designated as reference numeral 10. Conventional bicycle 10 includes a pedal crank assembly 12 rotatably mounted to a bicycle frame and positioned forward of a seat 14 and rearward of a front wheel. Pedal crank assembly 12 is coupled to a rear driven wheel by a chain. In this arrangement, when a pedal 16 is positioned at five o'clock, a significant amount of force (F) is used to place a corresponding crank bar 18 in tension, which is an inefficient use of energy when the goal is to use the pedaling force to rotate pedal crank assembly 12. Furthermore, the bicycle arrangement shown in FIG. 1 places a bicycle rider in a position wherein his or her legs are cramped under the upper portion of bent body. This cramped position limits the amount of driving force that may be imposed on the pedal crank assembly thereby reducing the efficiency of the bicycle.

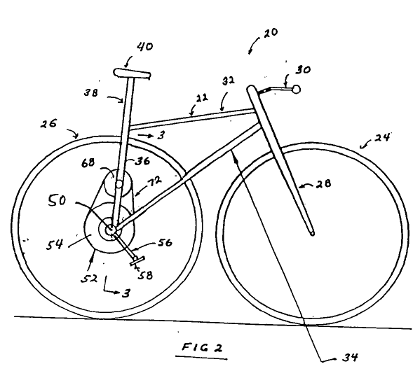

As best seen in FIG. 2, an improved bicycle arrangement in accordance with the present invention is shown and is designated as reference numeral 20. In general, the present invention provides an energy efficient bicycle by positioning a pedal crank assembly 52 approximately below or rearward of a bicycle seat 40 and on the axis of a rear driven wheel 26. When pedal crank assembly 52 is so positioned on the axis of a rear wheel, the upper portion of a bicycle rider tends to bend forward thereby allowing the legs of the rider to extend in a rearward direction. The position of the legs allows the rider to produce more driving force pushing generally rearward compared to a position where the legs are pushed forward and cramped under the body in a conventional bicycle arrangement as shown in FIG. 1. The present invention also includes additional features that provide further advantages, which will be described in more detail below.

As best seen in FIG. 2, bicycle 20 includes a frame 22 supported by a front wheel 24 and rear driven wheel 26. Frame 22 includes a front fork 28 that supports front wheel 24 and a pair of handle bars 30. A top frame member 32 and a down member 34 extend rearwardly from front fork 28 and are coupled with a rear fork 36. A seat post 38 extends upwardly from rear fork 36 and provides support for seat 40.

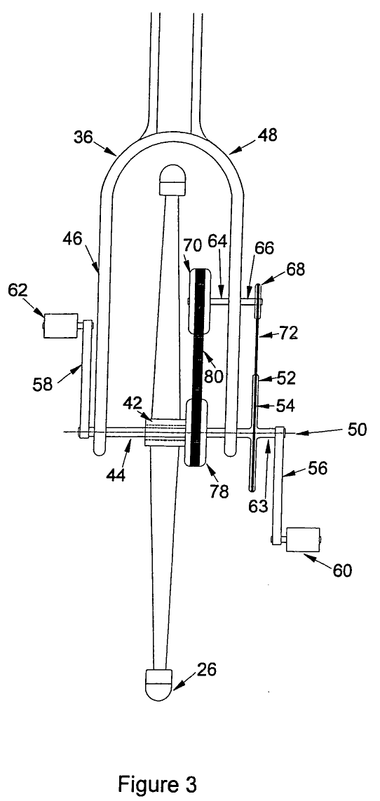

With additional reference to FIG. 3, rear wheel 26 includes a hub 42 that is rotatably mounted on a rear axle 44 that extends between a pair of rear fork members 46, 48. Rear axle 44 extends beyond rear fork members 46, 48 and rotates about a rear axis 50. Rear axis 50 also serves as the axis of rotation for rearwheel 26.

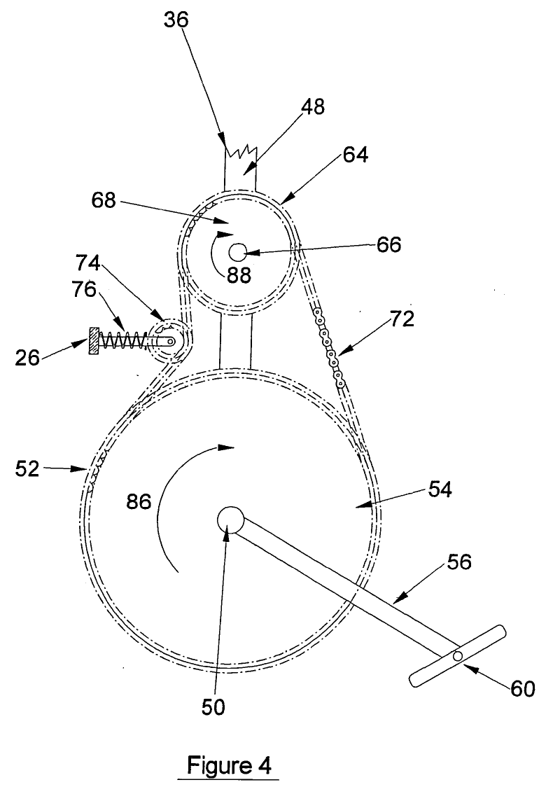

As best seen in FIGS. 3 and 4, pedal crank assembly 52 is positioned generally below or rearward of seat 40 and includes rear axle 44, a drive gear 54, a pair of crank bars 56, 58, and a pair of pedals 60, 62. Drive gear 54 is fixedly coupled to rear axle 44 and rotatably mounted to frame 22 about rear axis 50. Crank bar 56 extends radially from rear axis 50 and may be directly coupled to drive gear 54. In the alternative, crank bar 56 may be connected to drive gear 54 using an extension 63. Crank bar 58 is positioned on the opposite side of frame 22 and extends radially from rear axle 44. Pedals 60, 62 extend perpendicularly from crank bars 56, 58, respectively, so that a bicycle rider may rotate drive gear 54 about rear axis 50 to propel bicycle 20 in a desired direction.

As best seen in FIGS. 2 and 3, pedal crank assembly 52 rotates about rear axis 50 and is coaxial with rear wheel 26. In other words, the axis of rotation of pedal crank assembly 52 is coincident with the axis of rotation of rear wheel 26. As will be described in more detail below, pedal crank assembly 52 is driveably coupled with rear wheel 26 to allow for propulsion of the bicycle 20 when pedal crank assembly 52 is rotated relative to frame 22 about rear axis 50. It will be understood that pedal crank 50 is drivably coupled to rear wheel 26, but pedal crank 50 is not fixedly coupled to rear wheel 26. Thus, pedal crank 50 operates to drive rear wheel 26 and may rotate at a different rotational velocity relative to rear wheel 26.

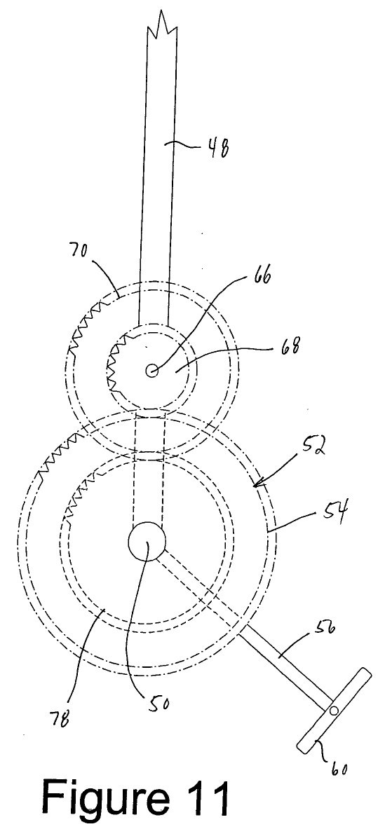

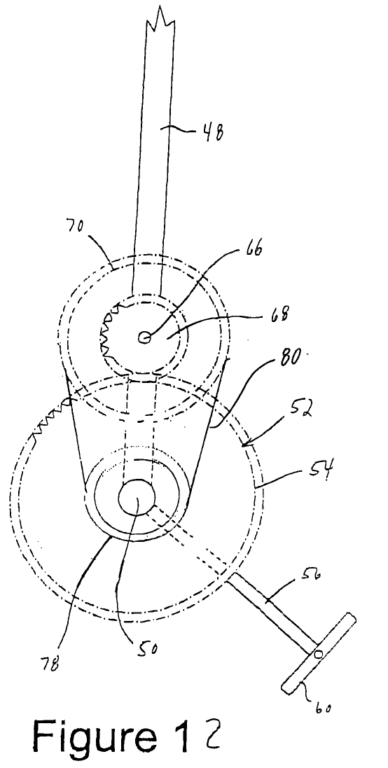

In order to driveably couple the pedal crank assembly 52 to rear wheel 26, pedal crank assembly 52 may be engaged with an auxiliary gear arrangement 64. Auxiliary gear arrangement 64 includes an auxiliary axle 66 rotatably coupled to frame 22 about a longitudinal axis of auxiliary axle 66. Auxiliary gear arrangement 64 may further include first and second auxiliary gears 68, 70 fixedly coupled to auxiliary axle 66. As such, first and second auxiliary gears 68, 70 rotate in conjunction with one another, but it will be understood that the diameters of each of the gears 68, 70 may be the same or different. In coupling the pedal crank assembly 52 with auxiliary gear arrangement 64, drive gear 54 may be engaged with first auxiliary gear 68 using a drive chain 72, or, in the alternative, drive gear 54 and first auxiliary gear 68 may be in a direct meshed or engaged connection as best seen in FIGS. 11 and 12. Using a direct meshed connection will require that the pedal crank assembly be rotated rearwardly in order to propel bicycle 20 in a forward direction. First and second auxiliary gears 68, 70 are positioned above pedal crank assembly 52 and between seat 40 and pedal crank assembly 52. Therefore, drive chain 72 is positioned in a generally vertical direction as seen in FIGS. 2 and 4.

With specific reference to FIG. 4, a third auxiliary gear 74 may be optionally engaged with drive chain 72 to eliminate slack and more firmly engage drive chain 72 so the drive chain 72 does not inadvertently fall off drive gear 54 and first auxiliary gear 68. Third auxiliary gear 74 may be mounted to frame 22 using a spring 76 so that drive chain 72 may be removed from drive gear 54 and first auxiliary gear 68 for maintenance purposes.

As best seen in FIG. 3, second auxiliary gear 70 is fixedly coupled to auxiliary axle 66 and is engaged with a one-way clutch gear 78. Clutch gear 78 is fixedly mounted to hub 42 of rear wheel 26 and therefore rotates in conjunction with rear wheel 26. Second auxiliary gear 70 may be engaged with clutch gear 78 using a drive belt 80 (FIGS. 3 and 12), or, in the alternative, second auxiliary gear 70 and clutch gear 78 may be in a direct meshed or engaged connection as best seen in FIG. 11. As such, any rotation of second auxiliary gear 70 will be transferred to clutch gear 78 causing rear wheel 26 to rotate about rear axis 50 thereby propelling bicycle 20.

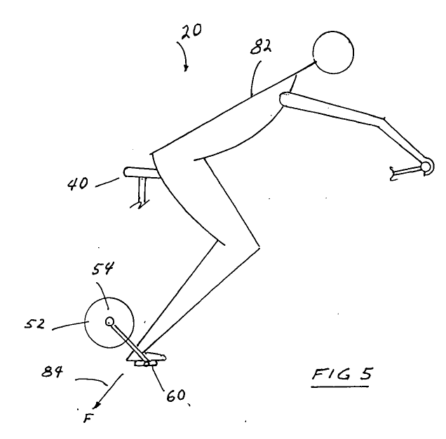

In operation, as best seen in FIG. 5, a bicycle rider 82 is positioned on seat 40 of bicycle 20 so that his or her feet are on pedals. Pedal crank assembly 52 is positioned approximately below or rearwardly of seat 40 so that pedal crank assembly 52 is coaxial with rear wheel 26 on rear axis 50. In this configuration, the upper portion of rider 82 is bent forward, which allows the legs of the rider to extend generally in a rearward direction. The rearward position of the legs allows the rider to produce more rearward driving force 84 compared to the conventional bicycle arrangement shown in FIG. 1.

As best seen in FIGS. 4 and 5, when rider 82 exerts force 84, drive gear 54 rotates in a clockwise direction indicated by arrow 86. If drive chain 72 is used to engage drive gear 54 with first auxiliary gear 68, drive chain 72 rotates first auxiliary gear 68 in a clockwise direction indicated by arrow 88. Referring to FIG. 3, since first auxiliary gear 68 and second auxiliary gear 70 are fixedly coupled by auxiliary axle 66, second auxiliary gear 70 will also rotate in the same direction as first auxiliary gear 68. The rotation of second auxiliary gear 70 is then transferred to clutch gear 78 using drive belt 80 or a meshed connection, which thereby rotates rear wheel 26 about rear axis 50 to propel bicycle 20. The speed at which bicycle 20 will travel when pedaling crank pedal assembly 52 will depend at least in part upon the size of the gears used for drive gear 54, first auxiliary gear 68, second auxiliary gear 70, and clutch gear 78.

The present invention described above provides a number of advantages over existing bicycle arrangements. For example, with reference to FIGS. 1 and 5, the present invention allows the upper portion of a bicycle rider's body to bend forward when cycling thereby enabling the rider to produce more driving force on pedal crank assembly 52 compared to a rider having his or her legs cramped under the bent body where pedal crank assembly 12 is positioned forward of the seat. The position of pedal crank assembly 52 in the present invention shows efficient use of driving force when the pedal is at the five o'clock position. In addition, some bicycle riders use their legs to both push and pull the pedals to generate forward propulsion. With the upper portion of the riders body bent forward, the legs can produce more driving force pulling up from a rear pedal position than they can when the legs are cramped up under a bent body when pedal crank assembly 12 is positioned forward of the seat.

In a three-hundred and sixty degree pedaling motion, the lower portion of pedaling past the three o'clock position is the more effective portion of pedaling. In a conventional bicycle arrangement 10, as best seen in FIG. 1, a significant percentage of driving force in the lower and more effective portion of pedaling is wasted since the applied force (F) in the general direction of the crank bar 18 is non-productive. When the position of pedal crank assembly 52 is shifted rearward of seat 40, as best seen in FIG. 5, more energy is directed toward propelling the bicycle. As such, less energy is wasted and a more energy efficient bicycle is provided. The present invention also eliminates any dead spots in the pedaling action in common bicycles when peddling in the twelve o'clock and six o'clock positions.

In a conventional bicycle, the frame is a bridge between front and rear wheels that carry the weight of the rider and the forces generated by the rider's legs. In the present invention, the majority of the rider's weight is directly transferred to the rear wheel, with a smaller weight transfer to the front wheel, thus reducing the frame required for a bridge. A lighter more efficient bicycle results since it requires less energy to propel the bicycle. Positioning the pedal crank assembly coaxial to the rear driven wheel also allows the space between the front and rear wheel to be reduced, which results in a bicycle that may be constructed with a shorter overall length. A shorter bicycle would require less material resulting in a lighter bicycle that us easier to propel. Further, the bicycle would be easier to lift up in the air, therefore allowing it to be used as an anchor-balanced mono-cycle.

The present invention also provides an additional advantage. In the present invention, first and second auxiliary gears 68, 70 are positioned above drive gear 54. Therefore, drive chain 72 can either be eliminated or extend in a generally vertical direction, which reduces the chance that drive chain 72 will become disengaged with first auxiliary gear 68 and drive gear 54 due to objects encountered on rugged terrain. This is more of a problem with conventional mountain bicycle arrangements where the drive chain extends generally horizontally from the drive gear to the rear wheel.

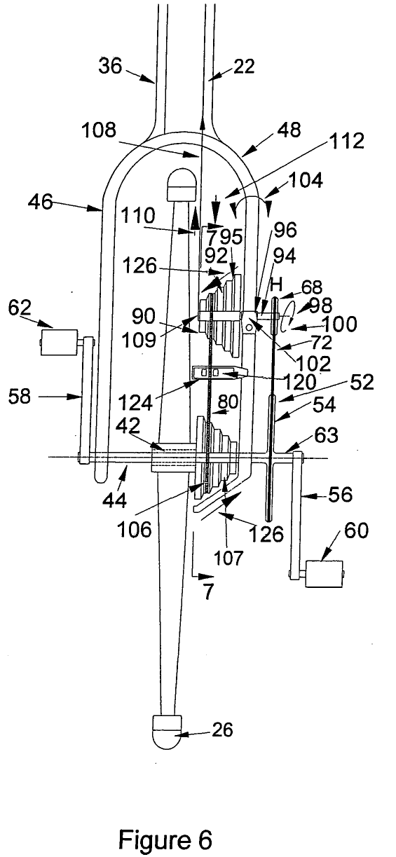

As best seen in FIG. 6, the present invention may further include a gear change mechanism 90 that allows a bicycle rider to change gears on bicycle 20. Gear change mechanism 90 includes a number of components that are similar to those discussed above. Therefore, these similar components will be labeled with the same reference numerals provided above and will not be discussed further.

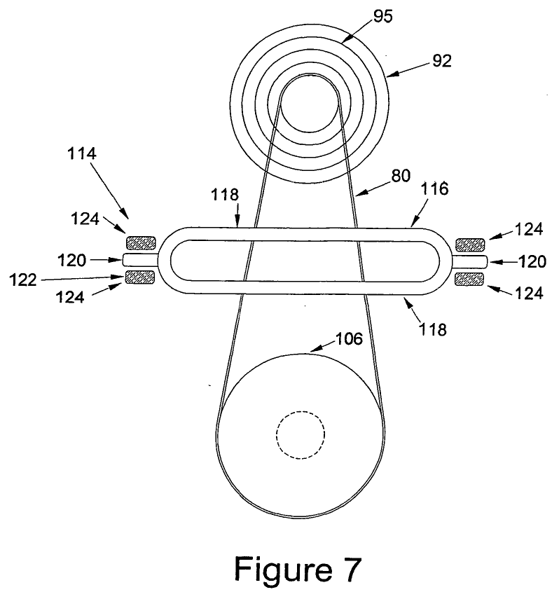

Gear changing mechanism 90 may include a driving gear set 92, which replaces the second auxiliary gear 70 shown in FIG. 3. As best seen in FIGS. 6 and 7, driving gear set 92 is fixedly coupled with an auxiliary axle 94 and first auxiliary gear 68. Driving gear set 92 may be a cone or a frustum having a stepped surface 95, which operates as a set of gears, wherein the diameter of driving gear set 92 tapers as it extends toward rear wheel 26. In the alternative, driving gear set 92 may include a plurality of separate gears, wherein one or more of the gears have diameters that are different sizes.

As stated above, driving gear set 92 is fixedly coupled with auxiliary axle 94. With reference to FIG. 6, auxiliary axle 94 is positioned within a sleeve 96 that is mounted to frame 22. In particular, auxiliary axle 94 may rotate about a longitudinal axis 98 of auxiliary axle 94, as shown with arrow 100, so that driving gear set 92 and first auxiliary gear 68 may conjunctively rotate relative to frame 22. Further, auxiliary axle 94 is rotatably coupled to frame 22 about a transverse axis 102 of auxiliary axle 94, as shown with arrow 104, to allow for the engagement and release of drive belt 80 from the gears in driving gear set 92, which will be described in more detail below. It will be understood that sleeve 96 may be fixedly coupled to frame while auxiliary axle 94 rotates about transverse axis 102 within sleeve 96, or the sleeve 96 itself may be rotatably coupled to frame 22 about transverse axis 102 thereby allowing for transverse rotation of auxiliary axle 94 positioned within sleeve 96.

As best seen in FIGS. 6 and 7, gear changing mechanism 90 also may include a driven gear set 106 that is fixedly coupled to hub 42 on rear wheel 26, and drivably connected to driving gear set 92 by drive belt 80. Driven gear set 106 may be either a cone or a frustum having a stepped surface 107, which operates as a set of gears, so that the diameter of driven gear set 106 tapers as it extends from rear wheel 26 to frame 22. In the alternative, driven gear set 106 may include a plurality of separate gears, wherein one or more of the gears have diameters that are different sizes.

Gear changing mechanism 90 further includes a cable 108 that is attached to a distal end 109 of auxiliary axle 94. The other end portion of cable 108, which is not shown, is controllably mounted to frame 22 of bicycle 20 so that the bicycle rider may control the transverse rotational movement 104 (i.e., tilt) of driving gear set 92 about transverse axis 102. Cable 108 may be moved in an upward direction 110 to rotate auxiliary axle 94 clockwise about axis 102 thereby controllably engaging drive belt 80 to a corresponding set of gears on driving gear set 92 and driven gear set 106. Cable 108 may also be moved in a downward direction 112 to rotate auxiliary axle 94 counter-clockwise about axis 102 thereby controllably releasing drive belt 80 from the gears on driving gear set 92 and driven gear set 106. In this position, drive belt 80 is capable of being moved to a different set of gears on driving gear set 92 and driven gear set 106.

When drive belt 80 is released from the gears on driving gear set 92 and driven gear set 106 by lowering cable 108 in direction 112, a guide member 114 may be used to shift drive belt 80 to a new set of gears on driving gear set 92 and driven gear set 106, as best seen in FIG. 7. Specifically, guide member 114 may include a pair of frames 116 (only one frame shown in FIG. 7) that are spaced apart and positioned on both sides of drive belt 80 so that drive belt 80 is sandwiched between frames 116. Each frame 114 may include two parallel cross-members 118 that are joined on opposite sides by opposing stems 120. Stems 120 are slidably positioned within a pair of tracks 122. Stems 120 on each of frames 116 are welded to spacers (not shown) holding frames 116 parallel but apart within tracks 122 a distance slightly greater than the thickness of drive belt 80. Each of tracks 122 include a pair of spaced apart bars 124 that are fixedly mounted to frame 22 as best seen in FIG. 6. A cable (not shown) may be attached to stems 120, or another portion of frames 116, to controllably shift the position of the frames 116 within tracks 122 in a direction that is transverse to a plane defined by drive belt 80. Since drive belt 80 is positioned between frames 116, frames 116 may be used to guide drive belt 80 to a desired position on driving gear set 92 and driven gear set 106 when the cable that is attached to stems 120 is adjusted.

In operation, when drive belt 80 is released from the gears on driving gear set 92 and driven gear set 106 by moving cable 108 in direction 112, the cable attached to stems 120 may be used to slide frames 116 relative to tracks 122 to guide drive belt 80 to a position on the gears on driving gear set 92 and driven gear set 106. Once drive belt 80 is in a desired position on driving gear set 92 and driven gear set 106, cable 108 may be raised in direction 110 to tighten the connection of drive belt 80 to driving gear set 92 and driven gear set 106 thereby preventing drive belt 80 from sliding out of position in a downward direction 126. The relative diameter sizes of the gears occupied by drive belt 80 on driving gear set 92 and driven gear set 108, in combination with the size of first auxiliary gear 68 and drive gear 54, will at least in part determine the speed at which bicycle 20 may be propelled.

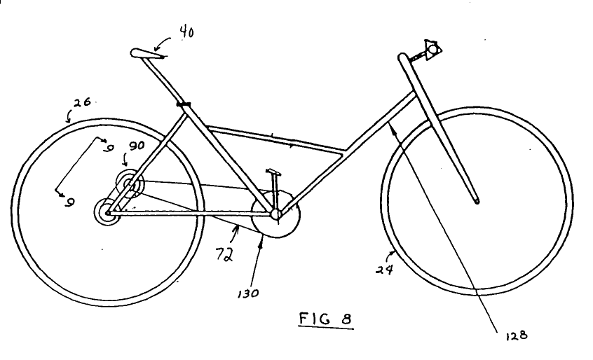

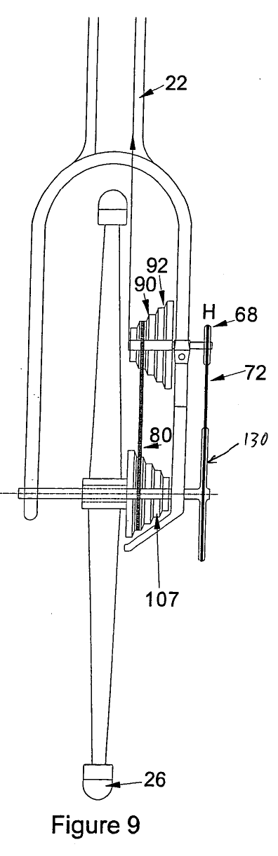

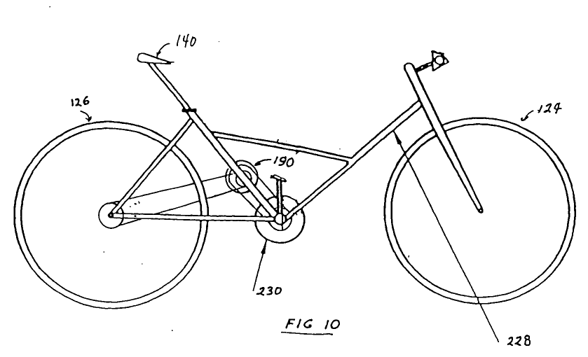

Furthermore, the gear change mechanism set forth may be used with a conventional bicycle frames 128, 228, as best seen in FIGS. 8, 9 and 10. Specifically, the configuration of gear change mechanism 90, 190 may be used in conjunction with a pedal crank assembly 130, 230 that is positioned forward of seat 40, 140 and rearward of front wheel 24, 124. Therefore, the pedal crank assembly 130, 230 is not coaxial with rear wheel 26, 126 in contrast to the previously discussed embodiments shown in FIGS. 2-7. As best seen in FIG. 8, the gear change mechanism 90 is positioned approximately below or rearward of seat 40. As best seen in FIG. 10, gear change mechanism 190 is mounted to the seat post and positioned between seat 140 and front wheel 124.

The gear change mechanism included in the present invention is beneficial in that it does not require conventional derailleur mechanisms that increase the maintenance on the bicycle, decrease the bicycle's reliability, and increase the cost of manufacturing the bicycle. Also, the gear changing mechanism provided herein allows the gears on the bicycle to be changed while the bicycle is stationary. Conventional gear changing mechanisms require that the pedal crank assembly be rotated so that the rear wheel is rotated at a reasonable speed in order to change the gears. Moreover, multiple derailleur mechanisms are used in existing bicycles, one derailleur for the pedal crank assembly and one derailleur for the rear wheel. The single gear changing mechanism disclosed in the present invention is sufficient to cover the same range of gears as is used with existing multiple derailleur configurations.

Although the present invention has been described in considerable detail with reference to certain preferred versions thereof, other versions are possible. Therefore, the spirit and scope of the appended claims should not be limited to the description of the preferred versions contained herein.

All features disclosed in the specification, including the claims, abstract, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent or similar purpose, unless expressly stated otherwise. Thus, unless expressly stated otherwise, each feature disclosed is one example only of a generic series of equivalent or similar features.

What is claimed is:

1. A bicycle including a seat mounted to a frame, and front and rear wheels rotatably mounted to the frame, the bicycle comprising:
a pedal crank assembly rotatably mounted to the frame, the pedal crank assembly positioned no further forward than approximately underneath the seat and on a rotational axis of the rear wheel, wherein the pedal crank assembly is driveably coupled with the rear wheel to allow for propulsion of the bicycle.

2. A bicycle in accordance with claim 1, wherein the pedal crank assembly is coaxial with the rear wheel.

3. A bicycle in accordance with claim 1, further comprising an auxiliary gear arrangement including:
an auxiliary axle rotatably coupled to the frame;
first and second auxiliary gears fixedly coupled to the auxiliary axle; and
a cutch gear fixedly coupled to the rear wheel, wherein the pedal crank assembly is engaged with the first auxiliary gear, and wherein the second auxiliary gear is engaged with the clutch gear to driveably couple the pedal crank assembly with the rear wheel.

4. A bicycle in accordance with claim 3, wherein the pedal crank assembly is coaxial with the rear wheel.

5. A bicycle in accordance with claim 3, wherein the pedal crank assembly includes:
a rear axle rotatably coupled to the frame;
a drive gear fixedly coupled to the rear axle;
at least one crank bar coupled to the drive gear, and
a pedal coupled to the at least one crank bar, wherein the rear axle is coaxial with the rear wheel.

6. A bicycle in accordance with claim 5, wherein the rear wheel is rotatably mounted on the rear axle.

7. A bicycle in accordance with claim 3, wherein the first and second auxiliary gears are positioned above the pedal crank assembly.

8. A bicycle in accordance with claim 7, wherein the first and second auxiliary gears are positioned between the seat and the pedal crank assembly.

9. A bicycle in accordance with claim 3, wherein the pedal crank assembly is directly engaged with the first auxiliary gear, and wherein the second auxiliary gear is directly engaged with the clutch gear.

10. A bicycle in accordance with claim 3, further comprising a drive belt that engages the second auxiliary gear with the clutch gear.

11. A bicycle in accordance with claim 10, wherein the pedal crank assembly is directly engaged with the first auxiliary gear.

12. A bicycle in accordance with claim 10, further comprising a drive chain that engages the pedal crank assembly with the first auxiliary gear.

13. A bicycle in accordance with claim 12, further comprising:
a spring mounted to the frame; and
a third auxiliary gear mounted to the spring, wherein the third auxiliary gear is coupled to the drive chain to take up slack on the drive chain and securely fasten the drive chain to the pedal crank assembly and the first auxiliary gear.

14. A bicycle in accordance with claim 1, further comprising:
an auxiliary axle rotatably coupled to the frame about a longitudinal axis and a transverse axis of the auxiliary axle;
a first auxiliary gear fixedly coupled to the auxiliary axle, the first auxiliary gear engaged with the pedal crank assembly;
a driving gear set fixedly coupled to the auxiliary axle; and
a driven gear set fixedly coupled to the rear wheel, wherein the driving gear set is coupled with the driven gear set so that the pedal crank assembly is driveably coupled to the rear wheel.

15. A bicycle in accordance with claim 14, wherein the pedal crank assembly is coaxial with the rear wheel.

16. A bicycle in accordance with claim 14, wherein the driving gear set is in the shape of a frustum.

17. A bicycle in accordance with claim 14, wherein the driven gear set is in the shape of a frustum.

18. A bicycle in accordance with claim 14, further comprising a drive belt that engages the driving gear set with the driven gear set.

19. A bicycle in accordance with claim 18, further comprising a cable coupled to the auxiliary axle, wherein the cable is adapted to rotate the auxiliary axle about the transverse axis of the auxiliary axle to engage and release the drive belt from at least one of the driving gear set and the driven gear set.

20. A bicycle in accordance with claim 19, further comprising:
a guide member positioned on opposite sides of the drive belt; and
at least one track mounted to the frame, wherein the guide member is slidably positioned within the track to change the position of the drive belt on at least one of the driving gear set and the driven gear set.

21. A bicycle in accordance with claim 20, wherein at least one cable is coupled with the guide member to slide the guide member within the at least one track.

22. A bicycle in accordance with claim 1, wherein the pedal crank assembly includes:
a rear axle rotatably coupled to the frame;
a drive gear fixedly coupled to the rear axle;
at least one crank bar coupled to the drive gear, and
a pedal coupled to the at least one crank bar, wherein the rear axle is coaxial with the rear wheel.

23. A bicycle in accordance with claim 22, wherein the rear wheel is rotatably mounted on the rear axle.

24. A bicycle including a seat mounted to a frame, and front and rear wheels rotatably mounted to the frame, the bicycle comprising:
a pedal crank assembly rotatably mounted to the frame, the pedal crank assembly positioned forward of the seat and rearward of the front wheel;
an auxiliary axle rotatably coupled to the frame about a longitudinal axis and a transverse axis of the auxiliary axle;
a first auxiliary gear fixedly coupled to the auxiliary axle, the first auxiliary gear engaged with the pedal crank assembly;
a driving gear set fixedly coupled to the auxiliary axle; and
a driven gear set fixedly coupled to the rear wheel, wherein the driving gear set is coupled with the driven gear set, and wherein the pedal crank assembly is driveably coupled with the rear wheel to allow for propulsion of the bicycle.

25. A bicycle in accordance with claim 24, further comprising a drive belt that engages the driving gear set with the driven gear set.

26. A bicycle in accordance with claim 25, further comprising a cable coupled to the auxiliary axle, wherein the cable is adapted to rotate the auxiliary axle about the transverse axis of the auxiliary axle to engage and release the drive belt from at least one of the driving gear set and the driven gear set.

27. A bicycle in accordance with claim 26, further comprising:
a guide member positioned on opposite sides of the drive belt; and
at least one track mounted to the frame, wherein the guide member is slidably positioned within the track to change the position of the drive belt on at least one of the driving gear set and the driven gear set.

28. A bicycle in accordance with claim 27, wherein at least one cable is coupled with the guide member to slide the guide member within the at least one track.

29. A bicycle in accordance with claim 24, wherein the auxiliary axle, the first auxiliary gear, and the driving gear set are positioned rearward of the seat.
